(19) United States
(12) Patent Application Publication
(10) Pub. No.: US 2010/0255745 A1
(43) Pub. Date: Oct. 7, 2010

(54) Article And Method Of Manufacturing Same

(76) Inventors: Donald Liles, Midland, MI (US); Bonnie Ludwig, Midland, MI (US)

Correspondence Address: HOWARD & HOWARD ATTORNEYS PLLC, 450 West Fourth Street, Royal Oak, MI, 48067, US

(21) Appl. No.: 12/743,700

(22) PCT Filed: Nov. 20, 2008
(86) PCT No.: PCT/US08/12956

§ 371 Date: May 19, 2010

(30) Foreign Application Priority Data
Nov. 20, 2007 (US) 61003726
Nov. 20, 2008 (US) PCT/US2008/012956

(51) Int. Cl. D04H 13/00; C08G 77/04; B05D 1/18

(52) U.S. Cl. 442/376; 525/475; 264/465; 427/436

(57) ABSTRACT

An article includes fibers formed from a compound having the general chemical formula R—Si—H. In this formula, R is an organic or an inorganic group. The fibers also have metal disposed thereon. The article is formed from a method including two steps. The method of forming the article includes the step of electrospinning the compound to form the fibers. The method also includes the step of disposing the metal onto the fibers to form the article.

### FIELD OF THE INVENTION

The present invention generally relates to an article and a method of manufacturing the article. More specifically, the article includes fibers which are formed from a particular compound and have a metal disposed thereon.

### DESCRIPTION OF THE RELATED ART

The development of fibers having micro- and nano-diameters is currently the focus of much research and development in industry, academia, and government. These types of fibers can be formed from a wide variety of organic and inorganic materials such as polyaniline, polypyrrole, polyvinylidene, polyacrylonitrile, polyvinyl chloride, polymethylmethacrylate, polythiophene, and iodine-doped polyacetylene. Fibers of this type have also been formed from hydrophilic biopolymers such as proteins, polysaccharides, collages, fibrinogens, silks, and hyaluronic acid, in addition to polyethylene and synthetic hydrophilic polymers such as polyethylene oxide.

Many of these types of fibers can be formed through a process known in the art as electrospinning. Electrospinning is a versatile method that includes use of an electrical charge to form a mat of fibers. Typically, electrospinning includes loading a solution into a syringe and driving the solution to a tip of the syringe with a syringe pump to form a droplet at the tip. Electrospinning also usually includes applying a voltage to the needle to form an electrified jet of the solution. The jet is then elongated and whipped continuously by electrostatic repulsion until it is deposited on a grounded collector, thereby forming the mat of fibers.

Fibers that are formed via electrospinning may be used in a wide variety of industries including in medical and scientific applications. More specifically, these types of fibers have been used to reinforce certain composites. These fibers have also been used to produce nanometer tubes that are used in medical dialysis, gas separation, osmosis, and in water treatment.

Although a wide variety of fibers have been made and used in many different applications, there remains an opportunity to form an article formed from fibers that are functionalized and that include metals disposed thereon. There also remains an opportunity to develop a method of forming such an article.

### SUMMARY OF THE INVENTION AND ADVANTAGES

The present invention provides an article and a method of forming the article. The article includes fibers formed from a compound having the general chemical formula R—Si—H. In this formula, R is an organic or inorganic group. The fibers also have a metal disposed thereon. The method of forming the article includes the step of electrospinning the compound to form the fibers. The method also includes the step of disposing the metal onto the fibers to form the article. The invention also provides an article of fibers which comprise the reaction product of the compound and the metal. The article can be formed efficiently and in a minimal number of steps using the method of this invention. In addition, the step of electrospinning allows for efficient formation of fibers having small diameters and for formation of hierarchical structures including nanostructures of the metal disposed on the fibers.

### BRIEF DESCRIPTION OF THE SEVERAL VIEWS OF THE DRAWINGS

Other advantages of the present invention will be readily appreciated, as the same becomes better understood by reference to the following detailed description when considered in connection with the accompanying drawings wherein:

FIG. 1A is a scanning electron microscope image of rhodium nanoparticles disposed on a fiber formed from the compound including a polymerization product of 90% by weight of a first silicon monomer including an organopolysiloxane represented by the general formula [R₃SiO_{1/2}][SiO_{4/2}], wherein R is a methyl group and 10% by weight of a second silicon monomer including a methylhydrogen silicone having a degree of polymerization of 50;

FIG. 1B is a magnified view of the rhodium nanoparticles shown in FIG. 1A;

FIG. 2A is a scanning electron microscope image of platinum nanoparticles disposed on a fiber formed from the compound including a polymerization product 90% by weight of a first silicon monomer including an organopolysiloxane represented by the general formula [R₃SiO_{1/2}][SiO_{4/2}], wherein R is a methyl group and 10% by weight of a second silicon monomer including a methylhydrogen silicone having a degree of polymerization of 50;

FIG. 2B is a magnified view of the platinum nanoparticles shown in FIG. 2A;

FIG. 3A is a scanning electron microscope image of silver nanoparticles disposed on a fiber formed from the compound including a polymerization product of 90% by weight of a first silicon monomer including an organopolysiloxane represented by the general formula [R₃SiO_{1/2}][SiO_{4/2}], wherein R is a methyl group and 10% by weight of a second silicon monomer including a methylhydrogen silicone having a degree of polymerization of 50;

FIG. 3B is a magnified view of the silver nanoparticles shown in FIG. 3A;

FIG. 4A is a scanning electron microscope image of palladium nanoparticles disposed on a fiber formed from the compound including a polymerization product of 90% by weight of a first silicon monomer including an organopolysiloxane represented by the general formula [R₃SiO_{1/2}][SiO_{4/2}], wherein R is a methyl group and 10% by weight of a second silicon monomer including a methylhydrogen silicone having a degree of polymerization of 50;

FIG. 4B is a magnified view of the palladium nanoparticles shown in FIG. 4A;

FIG. 5A is a scanning electron microscope image of gold nanoparticles disposed on a fiber formed from the compound including a polymerization product of 90% by weight of a first silicon monomer including an organopolysiloxane represented by the general formula [R₃SiO_{1/2}][SiO_{4/2}], wherein R is a methyl group and 10% by weight of a second silicon monomer including a methylhydrogen silicone having a degree of polymerization of 50;

FIG. 5B is a magnified view of the gold nanoparticles shown in FIG. 5A;

FIG. 6A is a scanning electron microscope image of iridium nanoparticles disposed on a fiber formed from the compound including a polymerization product of 90% by weight of a first silicon monomer including an organopolysiloxane represented by the general formula [R₃SiO_{1/2}][SiO_{4/2}], wherein R is a methyl group and 10% by weight of a second silicon monomer including a methylhydrogen silicone having a degree of polymerization of 50;

FIG. 6B is a magnified view of the iridium nanoparticles shown in FIG. 6A wherein the particles are less than 10 nanometers in diameter;

FIG. 7A is a scanning electron microscope image of a fiber formed from the compound including a polymerization product of a silicon monomer and an organic monomer;

FIG. 7B is a magnified view of the fiber shown in FIG. 7A;

FIG. 8A is a scanning electron microscope image of a fiber formed from the compound including a polymerization product of a first and a second silicon monomer;

FIG. 8B is a magnified view of the fiber shown in FIG. 8A;

FIG. 9 is a scanning electron microscope image of an article (e.g. a mat) comprising non-woven fibers that are electrospun and are formed from the reaction product of a compound having the general chemical formula R—Si—H, wherein R is an organic or an inorganic group; and

FIG. 10 is a schematic view generally illustrating an electrospinning apparatus.

### DETAILED DESCRIPTION OF THE INVENTION

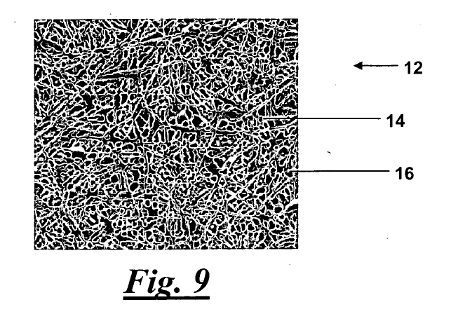

The instant invention provides an article (12) that includes fibers (14), as shown in FIG. 9. The article (12) may include a single layer of fibers (14) or multiple layers of fibers (14). As such, the article (12) typically has a thickness of at least 0.01 μm. More typically, the article (12) has a thickness of from about 1 μm to about 100 μm, more typically from about 25 μm to about 100 μm. The article (12) is not limited to any particular number of layers of fibers (14) and may have more than one layer. The fibers (14) may be formed by any method known in the art, may be woven or non-woven such that the article (12) itself may be woven or non-woven, and may exhibit a microphase separation. In one embodiment, the fibers (14) and the article (12) are non-woven and the article (12) is further defined as a mat. In another embodiment, the fibers (14) and the article (12) are non-woven and the article (12) is further defined as a web. Alternatively, the article (12) may be a membrane. The fibers (14) may also be uniform or non-uniform and may have any surface roughness. In one embodiment, the article (12) is a coating. It is also contemplated that the article (12) may be a fabric or a textile that may be elastic or non-elastic.

The article (12) may be a superhydrophobic fiber mat and may exhibit a water contact angle of greater than about 150 degrees. In various embodiments, the article (12) exhibits water contact angles of from 150 to 180, 155 to 175, 160 to 170, and 160 to 165, degrees. The article (12) may also exhibit a water contact angle hysteresis of below 15 degrees. In various embodiments, the article (12) exhibits water contact angle hystereses of from 0 to 15, 5 to 10, 8 to 13, and 6 to 12. The article (12) may also exhibit an isotropic or non-isotropic nature of the water contact angle and/or the water contact angle hysteresis. Alternatively, the article (12) may include domains that exhibit an isotropic nature and domains that exhibit a non-isotropic nature.

The fibers (14) may also be of any size and shape and are typically cylindrical. Typically, the fibers (14) have a diameter of from 0.01 to 100, more typically of from 0.05 to 10, and most typically of from 0.1 to 1, micrometers (μm). In various embodiments, the fibers (14) have a diameter of from 1 nm to 30 microns, from 1-500 nm, from 1-100 nm, from 100-300 nm, from 100-500 nm, from 50-400 nm, from 300-600 nm, from 400-700 nm, from 500-800 nm, from 500-1000 nm, from 1500-300 nm, from 2000-5000 nm, or from 3000-4000 nm. The fibers (14) also typically have a size of from of from 5 to 20 microns and more typically have a size of from 10-15 microns. However, the fibers (14) are not limited to any particular size. The fibers (14) are often referred to as “fine fibers”, which encompasses fibers having both micron-scale diameters (i.e., fibers having a diameter of at least 1 micron) and fibers having nanometer-scale diameters (i.e., fibers) having a diameter of less than 1 micron). The fibers (14) may also have a glass transition temperature (T_{g}) of from 25° C. to 500° C.

The fibers (14) may also be connected to each other by any means known in the art. For example, the fibers (14) may be fused together in places where they overlap or may be physically separate such that the fibers (14) merely lay upon each other in the article (12). It is contemplated that the fibers (14), when connected, may form a web or mat having pore sizes of from 0.01 to 100 μm. In various embodiments, the pore sizes range in size from 0.1-100, 0.1-50, 0.1-10, 0.1-5. 0.1-2, or 0.1-1.5, microns. It is to be understood that the pore sizes may be uniform or not uniform. That is, the article (12) may include differing domains with differing pore sizes in each domain or between domains. Further, the fibers (14) may have any cross sectional profile including, but not limited to, a ribbon-like cross-sectional profile, an oval cross-sectional profile, a circular cross-sectional profile, and combinations thereof. As shown in FIG. 9, in some embodiments, “beading” (16) of the fiber can be observed, which may be acceptable for most applications. The presence of beading (16), the cross-sectional profile of the fiber (varying from circular to ribbonous), and the fiber diameter are functions of the conditions of a method in which the fibers (14) are formed. The method is described in further detail below.

In some embodiments, the fibers (14) are also fire resistant. Fire resistance of the fibers (14), particularly the non-woven mat including the fibers (14), is tested using the UL-94V-0 vertical burn test on swatches of the non-woven mat deposited onto aluminum foil substrates. In this test, a strip of the non-woven mat is held above a flame for about 10 seconds. The flame is then removed for 10 seconds and reapplied for another 10 seconds. Samples are observed during this process for hot drippings that spread the fire, the presence of afterflame and afterglow, and the burn distance along the height of the sample. For non-woven mats including the fibers (14) in accordance with the instant invention, intact fibers (14) are typically observed beneath those that burn. The incomplete combustion of the non-woven mats is evidence of self-quenching, a typical behavior of fire-retardant materials and is deemed excellent fire resistance. In many circumstances, the non-woven mats may even achieve UL 94 V-0 classification. Without intending to be bound by any particular theory, it is believed that the fire resistance is typically attributable to a low ratio of organic groups to silicon atoms in the fibers (14). The low ratio of organic groups to silicon atoms is attributable to the absence of organic polymers and organic copolymers in the fibers (14). However, it is also contemplated that the fire resistance may be due to factors other than the low ratio of organic groups to silicon atoms in the fibers (14).

The fibers (14) are formed from a compound having the general chemical formula R—Si—H wherein R is an organic or inorganic group. The Si—H is a functional group bonded to the “R” group and functionalizes the overall compound. The Si—H group may be bonded anywhere within the R group. For example, if R is further defined as a polymer, the Si—H group may be bonded to any atom within the polymer and is not limited to being bonded to a pendant group or a terminal group. It is to be understood that more than one hydrogen atom may be bonded to the silicon atom of the Si—H group. In addition, it is to be understood that the terminology “group” is also commonly referred to in the art as a “moiety,” i.e., a specific segment of the compound.

The compound may include monomers, dimers, oligomers, polymers, pre-polymers, co-polymers, block polymers, star polymers, graft polymers, random co-polymers, and combinations thereof. As introduced above, the compound has the general formula (R—Si—H) wherein R is an organic or inorganic group. Non-limiting examples of common organic groups include alkyl groups, alkenyl groups, alkynyl groups, acyl halide groups, alcohol groups, ketone groups, aldehyde groups, carbonate groups, carboxylate groups, carboxylic acid groups, ether groups, ester groups, peroxide groups, amide groups, aramid groups, amine groups, imine groups, imide groups, azide groups, cyanate groups, nitrate groups, nitrile groups, nitrite groups, nitro groups, nitroso groups, benzyl groups, toluene groups, pyridine groups, phosphine groups, phosphate groups, sulfide groups, sulfone groups, sulfoxide groups, thiol groups, halogenated derivatives thereof, and combinations thereof. Non-limiting examples of common inorganic groups include silicone groups, siloxane groups, silane groups, transition metal compounds, and combinations thereof. In some embodiments, the compound itself may be further defined as a silicone, a siloxane, a silane, an organic derivative thereof, or a polymeric derivative thereof.

In one embodiment, the compound is further defined as a monomer which has the general chemical formula R—Si—H. The monomer may be any organic or inorganic monomer and may include any of the organic or inorganic groups described above or may be further defined as any of the monomers described in further detail below so long as the monomer is functionalized with the Si—H group. In another embodiment, the monomer is selected from the group of silanes, siloxanes, and combinations thereof and is functionalized with the Si—H group. In a further embodiment, the monomer is selected from the group of organosilanes, organosiloxanes, and combinations thereof and is functionalized with the Si—H group. Of course, if the monomer is further defined as a silane or as an organosilane, the silane or organosilane may have one Si—H group or more than one Si—H group. Alternatively, the compound may be further defined as a mixture of the monomer having the general chemical formula R—Si—H and a polymer or may be further defined as a polymer. So long as the compound includes the Si—H group, the polymer need not have the general formula R—Si—H. That is, the monomer or the polymer or both the monomer and polymer may include the Si—H group. The polymer may include the polymerization product of the monomers described above or those described in greater detail below. It is also contemplated that the compound may include more than one polymer including, but not limited to, conductive organic and inorganic polymers such as polythiophene, polyacetylene, polypyrrole, polyaniline, polysilane, polyvinylidene, polyacrylonitrile, polyvinyl chloride, polymethylmethacrylate, iodine-doped polyacetylene and combinations thereof. In one embodiment, the compound is further defined as a mixture of the monomer having the general chemical formula R—Si—H and the polymer wherein the monomer is dissolved in the polymer. The monomer and/or polymer may be present in any amount. In various embodiments, the monomer having the general chemical formula R—Si—H is typically present in the compound in an amount of less than 25 and most typically in an amount of less than 10, percent by weight.

Typically, the compound has a number average molecular weight (Mₙ) such that the compound is not volatile at room temperature and atmospheric pressure. However, the compound is not limited to such a number average molecular weight. In one embodiment, the compound has a number average molecular weight of greater than about 100,000 g/mol. In various other embodiments, the compound has number average molecules weights of from 100,000-5,000,000, from 100,000-1,000,000, from 100,000-500,000, from 200,000-300,000, of higher than about 250,000, or of about 150,000, g/mol. In one embodiment in which the compound is further defined as the monomer having the general chemical formula R—Si—H, the compound has a number average molecular weight of less than 50,000 g/mol. In another embodiment, in which the compound is further defined as the polymer, the compound has a number average molecular weight of greater than 50,000 g/mol, and more typically of greater than 100,000 g/mol. However, the monomer may have a number average molecular weight of greater than 50,000 g/mol and/or the polymer may have a number average molecular weight of less than 100,000 g/mol. Alternatively, the compound may have a number average molecular weight of at least about 300 g/mol, of from about 1,000 to about 2,000 g/mol, or of from about 2,000 g/mol to about 2,000,000 g/mol. In other embodiments, the compound may have a number average molecular weight of greater than 350 g/mol, of from about 5,000 to about 4,000,000 g/mol, or of from about 500,000 to about 2,000,000 g/mol.

R may be further defined as a polymerization product of at least a first and a second organic monomer so long as the compound has the general formula R—Si—H, i.e., so long as the polymerization product of the first and second organic monomers is functionalized with the Si—H group. It is to be understood that the first and second organic monomers may include polymerized groups and remain monomers so long as they retain an ability to be polymerized. The first and second organic monomers may be selected from the group of alkylenes, styrenes, acrylates, urethanes, esters, amides, aramids, imides, and combinations thereof. Alternatively, the first and second organic monomers may be selected from the group of polyisobutylenes, polyolefins, polystyrenes, polyacrylates, polyurethanes, polyesters, polyamides, polyaramids, polyetherimides, and combinations thereof. In one embodiment, the first and second organic monomers are selected from the group of acrylates, alkenoates, carbonates, phthalates, acetates, itaconates, and combinations thereof. Suitable examples of acrylates include, but are not limited to, alkylhexylacrylates, alkylhexylmethacrylates, methylacrylate, methylmethacrylate, glycidyl acrylate, glycidyl methacrylate, allyl acrylates, allyl methacrylates, and combinations thereof. The first and second organic monomers may include only acrylate or methacrylate functionality. Alternatively, the first and second organic monomers may include both acrylate functionality and methacrylate functionality.

Referring back to the alkenoates above, suitable examples of alkenoates include, but are not limited to, alkyl-N-alkenoates. Suitable examples of carbonates include, but are not limited to, alkyl carbonates, allyl alkyl carbonates, diallyl carbonate, and combinations thereof. Suitable itaconates include, but are not limited to, alkyl itaconates. Non-limiting examples of suitable acetates include alkyl acetates, allyl acetates, allyl acetoacetates, and combinations thereof. Non-limiting of examples of phthalates include, but are not limited to, allyl phthalates, diallyl phthalates, and combinations thereof. Also useful are a class of conductive monomers, dopants, and macromonomers having an average of at least one free radical polymerizable group per molecule and the ability to transport electrons, ions, holes, and/or phonons. It is also contemplated that the first and second organic monomers may include compounds including acryloxyalkyl groups, methacryloxyalkyl groups, and/or unsaturated organic groups including, but not limited to, alkenyl groups having 2-12 carbon atoms, alkynyl groups having 2-12 carbon atoms, and combinations thereof. The unsaturated organic groups may include radical polymerizable groups in oligomeric and/or polymeric polyethers. The first and second organic monomers may also be substituted or unsubstituted, may be saturated or unsaturated, may be linear or branched, and may be alkylated and/or halogenated.

The first and second organic monomers may also be substantially free of silicon (i.e., silicon atoms and/or compounds containing silicon atoms). It is to be understood that the terminology “substantially free” refers to a concentration of silicon of less than 5,000, more typically of less than 900, and most typically of less than 100, parts of compounds that include silicon atoms, per one million parts of the first and/or second organic monomers. It is also contemplated that the first and second organic monomers that are polymerized to form R may be totally free of silicon even though the overall compound has the general formula R—Si—H.

Alternatively, R may be further defined as a polymerization product of at least a silicon monomer and an organic monomer so long as the compound has the general formula R—Si—H, i.e., so long as the polymerization product of at least the silicon monomer and the organic monomer is functionalized with the Si—H group. It is contemplated that the organic monomer and/or silicon monomer may be present in the compound in any volume fraction. In various embodiments, the organic monomer and/or silicon monomer are present in volume fractions of from 0.05-0.9, 0.1-0.6, 0.3-0.5, 0.4-0.9, 0.1-0.9, 0.3-0.6, or 0.05-0.9.

The organic monomer may be any of the aforementioned first and/or second organic monomers or any known in the art. The terminology “silicon monomer” includes any monomer that includes at least one silicon (Si) atom such as silanes, siloxanes, silazanes, silicones, silicas, silenes, and combinations thereof. It is to be understood that the silicon monomer may include polymerized groups and remain a silicon monomer so long as it retains an ability to be polymerized. In one embodiment, the silicon monomer is selected from the group of organosilanes, organosiloxanes, and combinations thereof. In another embodiment, the silicon monomer is selected from the group of silanes, siloxanes, and combinations thereof.

The silicon monomer may include acryloxyalkyl- and methacryloxyalkyl-functional silanes also known as acrylic functional silanes, acryloxyalkyl- and methacryloxyalkyl-functional organopolysiloxanes, and combinations thereof. The silicon monomer may also have an average of at least one, or at least two, free radical polymerizable groups and an average of 0.1 to 50 mole percent of the free radical polymerizable groups including unsaturated organic groups. The unsaturated organic groups may include, but are not limited to, alkenyl groups, alkynyl groups, acrylate-functional groups, methacrylate functional groups, and combinations thereof. “Mole percent” of the unsaturated organic groups is defined as a ratio of a number of moles of unsaturated organic groups including siloxane groups in the silicon monomer to a total number of moles of siloxane groups in the compound, multiplied by 100. Further, the silicon monomer may include units of the formula RSiO_{3/2} wherein R is selected from the group of a hydrogen atom, an organic radical, or a combination thereof with the proviso that the silicon monomer include at least one hydrogen atom. Still further, the silicon monomer may include an organosilane selected from the group of tri-sec butyl silane, tri-butyl silane, and combinations thereof.

The silicon monomer may also include compounds including a functional group incorporated in the free radical polymerizable group. These compounds may be monofunctional or multifunctional with respect to the non-radical reactive functional group and may allow for polymerization of the silicon monomer to linear polymers, branched polymers, copolymers, cross-linked polymers, and combinations thereof. The functional group may include any known in the art used in addition and/or condensation curable compositions.

Alternatively, the silicon monomer may include an organosilane having the general structure:

R′ₙSi(OR″)₄₋ₙ

wherein n is an integer of less than or equal to 4. Typically at least one of R′ and R″ independently includes the free radical polymerizable group. However, R′ and/or R″ may include non-free radical polymerizable groups. Each of R′ and/or R″ may include a monovalent organic group free of aliphatic unsaturation. The R′ and/or R″ may each independently include one of a hydrogen, a halogen atom, and an organic group including, but not limited to, alkyl groups, haloalkyl groups, aryl groups, haloaryl groups, alkenyl groups, alkynyl groups, acrylate and methacrylate groups. In one embodiment, R′ and/or R″ may each independently include linear and branched hydrocarbon groups containing chains of from 1 to 5 (C₁-C₅) carbon atoms (such as methyl, ethyl, propyl, butyl, isopropyl, pentyl, isobutyl, sec-butyl groups, etc), linear and branched C₁-C₅ hydrocarbon groups containing carbon and fluorine atoms, aromatic groups including phenyl, naphthyl and fused ring systems, C₁-C₅ ethers, C₁-C₅ organohalogens, C₁-C₅ organoamines, C₁-C₅ organoalcohols, C₁-C₅ organoketones, C₁-C₅ organoaldehydes, C₁-C₅ organocarboxylic acids, and C₁-C₅ organoesters. More typically, R′ and/or R″ may include, but are not limited to, linear and branched hydrocarbon groups containing chains of from 1 to 3 (C₁-C₃) carbon atoms (such as methyl, ethyl, propyl, and isopropyl groups), linear and branched C₁-C₃ hydrocarbon groups containing carbon and fluorine atoms, phenyl, C₁-C₃ organohalogens, C₁-C₃ organoamines, C₁-C₃ organoalcohols, C₁-C₃ organoketones, C₁-C₃ organoaldehydes, and C₁-C₃ organoesters. In one embodiment, R′ and/or R″ is independently selected from the group of aromatic groups and C₁-C₃ hydrocarbon groups, provided that both aromatic groups and C₁-C₅ hydrocarbon groups are present in the organopolysiloxane. Alternatively, R′ and/or R″ may represent the product of a crosslinking reaction, in which case R′ and/or R″ may represent a crosslinking group. Alternatively, the R′ and/or R″ may also each independently include other organic functional groups including, but not limited to, glycidyl groups, amine groups, ether groups, cyanate ester groups, isocyano groups, ester groups, carboxylic acid groups, carboxylate salt groups, succinate groups, anhydride groups, mercapto groups, sulfide groups, azide groups, phosphonate groups, phosphine groups, masked isocyano groups, hydroxyl groups, and combinations thereof. The monovalent organic group typically has from 1 to 20 and more typically from 1 to 10, carbon atoms. The monovalent organic group may include alkyl groups, cycloalkyl groups, aryl groups, and combinations thereof. The monovalent organic group may still further include an alkyloxypoly(oxylalkylene) group, halogen substituted versions thereof, and combinations thereof. Additionally, the monovalent organic group may include a cyanofunctional group, a halogenated hydrocarbon group, a carbazole group, an aliphatic unsaturated group, acrylate groups, methacrylate groups, and combinations thereof.

The silicon monomer may also include, but is not limited to, 3-methacryloxypropyltrimethoxysilane, methacryloxymethyltrimethoxysilane, 3-methacryloxypropyltriethoxysilane, 3-acryloxypropyltrimethoxysilane, acryloxymethyltrimethoxysilane, 3-methacryloxypropyltrimethylsilane, 3-methacryloxypropyldimethylmonomethoxysilane, 3-methacryloxypropylmethyldimethoxysilane, 3-acryloxypropyltriethoxysilane, 3-acryloxypropyldimethylmonomethoxysilane, 3-acryloxylpropyltrimethylsilane, vinyltrimethoxysilane, allyltrimethoxysilane, 1-hexenyltrimethoxysilane, tetra-(allyloxysilane), tetra-(3-butenyl-1-oxy)silane, tri-(3-butenyl-1-oxy)methylsilane, di-(3-butenyl-1-oxy)dimethylsilane, 3-butenyl-1-oxy trimethylsilane, and/or combinations thereof.

The silicon monomer may have a linear, branched, hyperbranched, or resinous structure. The silicon monomer may include at least one of an acrylate group and a methacrylate group. In another embodiment, the silicon monomer includes a compound formed by copolymerizing organic compounds having polymeric backbones with the silicon monomer such that there is an average of at least one free radical polymerizable group per copolymer. Suitable organic compounds include, but are not limited to, hydrocarbon based polymers, polybutadienes, polyisoprenes, polyolefins, polypropylene and polyethylene, polypropylene copolymers, polystyrenes, styrene butadiene, and acrylonitrile butadiene styrene, polyacrylates, polyethers, polyesters, polyamides, aramids, polycarbonates, polyimides, polyureas, polymethacrylates, partially fluorinated or perfluorinated polymers, fluorinated rubbers, terminally unsaturated hydrocarbons, olefins, and combinations thereof. The silicon monomer can also include a copolymer including polymers having multiple organic functionality, multiple organopolysiloxane functionality, and combinations of organopolysiloxanes with the organic compounds. The copolymer may include repeating units in a random, grafted, or blocked arrangement.

Further, the silicon monomer may be a liquid, a gum, or a solid, and may have any viscosity. If the silicon monomer is a liquid, the viscosity may be equal to or greater than 0.001 Pa·s at 25° C. If the silicon monomer is a gum or a solid, the resin or solid may become flowable at elevated temperatures or by application of shear.

The silicon monomer may also include a compound having at least one of the following formulae:

(a) R¹₃SiO(R¹₂SiO)ₐ(R¹R²SiO)_{b}SiR¹₃;

(b) R³₂R⁴SiO(R³₂SiO)_{c}(R³R⁴SiO)_{d}SiR³₂R⁴;

(c) R³₂R⁴SiO(R³₂SiO)_{c}(R³R⁴SiO)_{d}SiR³₃; and

(d) combinations thereof.

In Formula (a), a and b are integers and each typically has an average value of less than or equal to 20,000 and b typically has an average value of at least one. Also, R¹ typically includes a monovalent organic group such as an acrylic functional group, an alkyl group, an alkenyl group, and alkynyl group, an aromatic group, a cyanoalkyl groups, a halogenated hydrocarbon group, an alkenyloxypoly(oxyalkyene) group, an alkyloxypoly(oxyalkyene) group, a halogen substituted alkyloxypoly(oxyalkyene) group, an alkoxy group, an aminoalkyl group, an epoxyalkyl group, an ester group, a hydroxyl group, an isocyanate group, a carbamate group, an aldehyde group, an anhydride group, a carboxylic acid group, a carbazole group, an oxime group, an aminoxy group, an alkeneoxy group, an acryl group, an acetoxy group, salts thereof, halogenated derivatives thereof, and combinations thereof. R² typically includes an unsaturated monovalent organic group. The unsaturated monovalent organic group may include, but is not limited to, alkenyl groups, alkynyl groups, acrylic groups, and combinations thereof.

In Formulae (b) and (c), c and d are integers and each typically has an average value of less than or equal to 20,000. In this formula, each R³ may independently be the same or may be different from R¹. Additionally, each R⁴ may independently include an unsaturated organic group such as those above.

In yet another embodiment, the silicon monomer may include, but is not limited to, 1,3-bis(methacryloxypropyl)tetramethyldisiloxane, 1,3-bis(acryloxypropyl)tetramethyldisiloxane, 1,3-bis(methacryloxymethyl)tetramethyldisiloxane, 1,3-bis(acryloxymethyl)tetramethyldisiloxane, α, ω̅-methacryloxymethyldimethylsilyl terminated polydimethylsiloxane, methacryloxypropyl-terminated polydimethylsiloxane, α, ω̅-acryloxymethyldimethylsilyl terminated polydimethylsiloxane, methacryloxypropyldimethylsilyl terminated polydimethylsiloxane, α, ω̅-acryloxypropyldimethylsilyl terminated polydimethylsiloxane, pendant acrylate and methacrylate functional polymers such as poly(acryloxypropyl-methylsiloxy) polydimethylsiloxane and poly(methacryloxypropyl-methylsiloxy) polydimethylsiloxane copolymers, telechelic polydimethylsiloxanes having multiple acrylate or methacrylate functional groups, and combinations thereof. Other compounds suitable for use include, but are not limited to, monofunctional methacrylate or methacrylate terminated organopolysiloxanes. The silicon monomer may also include a mixture of liquids differing in degree of functionality and/or free radical polymerizable groups. For example, the silicon monomer may include a tetra-functional telechelic polydimethylsiloxane.

Further, the silicon monomer may include organopolysiloxane resins having the following structures:

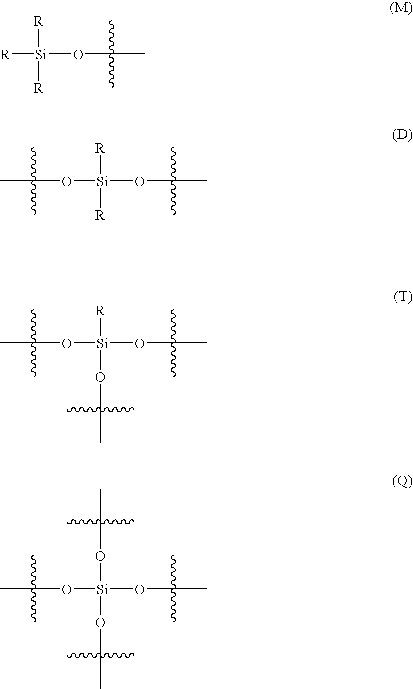

wherein each of M, D, T, and Q independently represent functionality of structural groups of organopolysiloxanes. Specifically, M represents a monofunctional group R₃SiO_{1/2}. D represents a difunctional group R₂Si0_{2/2}. T represents a trifunctional group RSi0_{3/2}. Q represents a tetrafunctional group Si0_{4/2}.

If the silicon monomer includes an organopolysiloxane resin, the organopolysiloxane resin may include MQ resins including R⁵₃SiO_{1/2} groups and SiO_{4/2} groups, TD resins including R⁵SiO_{3/2} groups and R⁵₂SiO_{2/2} groups, MT resins including R⁵₃SiO_{1/2} groups and R⁵SiO_{3/2} groups, MTD resins including R⁵₃SiO_{1/2} groups, R⁵SiO_{3/2} groups, and R⁵₂SiO_{2/2} groups, and combinations thereof.

In these resins, each R⁵ includes a monovalent organic group. R⁵ typically has from 1 to 20 and more typically has from 1 to 10, carbon atoms. Suitable examples of the monovalent organic groups include, but are not limited to, those disclosed above relative to R′ and R″.

Some specific examples of suitable resins that are useful include, but are not limited to, M^{Methacryloxymethyl}Q resins, M^{Methacryloxypropyl}Q resins, MT^{Methacryloxymethyl}T resins, MT^{Methacryloxypropyl}T resins, MDT^{Methacryloxymethyl}T^{Phenyl}T resins, MDT^{Methacryloxypropyl}T^{Phenyl}T resins, M^{Vinyl}T^{Phenyl} resins, TT^{Methacryloxymethyl} resins, TT^{Methacryloxypropyl} resins, T^{Phenyl}T^{Methacryloxypropyl} resins, T^{Phenyl}T^{Methacryloxypropyl} resins, TT^{Phenyl}T^{Methacryloxypropyl} resins, and TT^{Phenyl}T^{Methacryloxypropyl} resins, MQ resins, trimethyl capped MQ resins, T (Ph) resins, T propyl/T (Ph) resins, trimethyl capped MQ resins blended with linear silicone, and combinations thereof, where M, D, T, and Q are the same as described above.

In alternative embodiments, R may be further defined as the polymerization product of at least two silicon monomers so long as the compound has the general formula R—Si—H, i.e., so long as the polymerization product of the at least two silicon monomers is functionalized with the Si—H group. In these embodiments, R may substantially free of carbon, i.e., substantially free of the polymerization product of organic monomers. It is to be understood that the terminology “substantially free” refers to a concentration of carbon of less than 5,000, more typically of less than 900, and most typically of less than 100, parts of compounds that include carbon atoms, per one million parts of the compound. It is also contemplated that the silicon monomers may be totally free of carbon. The two silicon monomers may be any of the aforementioned silicon monomers and may be the same or different from each other.

In one embodiment, R includes an organopolysiloxane that is functionalized with the Si—H, such that the compound has the general formula R—Si—H. This organopolysiloxane may include siloxane units having an average unit formula of R′ₓSiO_{y/2}, i.e., R⁶ₓSiO_{y/2}. In one embodiment, R⁶ is selected from the group of an inorganic group, an organic group, and combinations thereof, x is from about 0.1 to about 2.2 and y is from about 1.8 to about 3.9. More typically, x is from about 0.1 to about 1.9 and y is from about 2.1 to about 3.9. Most typically, x is from about 0.5 to about 1.5 and y is from about 2.5 to about 3.5. To explain, the above general formula, and values for x and y, represent an average formula of the organopolysiloxane. As such, it is to be appreciated that the above general formula represents organopolysiloxanes that may include M, D, T, and/or Q units, and any combination of such units. As known in the art, M units are represented by the general formula R₃SiO_{1/2}, D units are represented by the general formula R₂SiO_{2/2}, T units are represented by the general formula R₁SiO_{3/2}, and Q units are represented by the general formula SiO_{4/2}. With reference to the above more and most typical values for x and y, it is preferred that these embodiments include at least some Q and/or T units, thereby providing that these embodiments have at least a portion of a resinous component (i.e., a branched organopolysiloxane as opposed to pure linear organopolysiloxanes, which includes mainly D units with the backbone capped by M units). In one embodiment, the organopolysiloxane includes only T units. In another embodiment, the organopolysiloxane includes only M and Q units. In another embodiment, the organopolysiloxane includes a physical blend (i.e., non-chemical blend) of a resinous component and a linear component. Of course, it is to be appreciated that the organopolysiloxane, in addition to possibly including any combination of M, D, T, and Q units, may also include any combination of separate components including only M and D units, only M and T units, only M, D, and T units, only M and Q units, only M, D, and Q units, or only M, D, T, and Q units.

In the above general formula, R⁶ may be selected from the group of oxygen-containing groups, organic groups free of oxygen, and combinations thereof. For example, R⁶ may comprise a substituent selected from the group of linear or branched C₁ to C₅ hydrocarbon groups containing a halogen atom. Alternatively, R⁶ may comprise a substituent selected from the group of linear or branched C₁ to C₅ hydrocarbon groups optionally containing:
1.) an amino group,
2.) an alcohol group,
3.) a ketone group,
4.) an aldehyde group, or
5.) an ester group.
   Alternatively, R⁶ may comprise a substituent selected from the group of aromatic groups. Further, R⁶ may comprise any combination of the above substituents set forth as suitable for R⁶. For example, the R⁶ may include, but is not limited to, any of the R′ and/or R″ groups described above. In one embodiment, R⁶ may represent the product of a crosslinking reaction, in which case R⁶ may represent a crosslinking group in addition to another polyorganosiloxane chain.

One specific example of an organopolysiloxane that is suitable for purposes of the instant invention includes units having an average unit formula of R⁷SiO_{3/2}, where R⁷ is selected from the group of phenyl groups, methyl groups, and combinations thereof. Another specific example of a polyorganosiloxane that is suitable for purposes of the instant invention includes units having an average unit formula of R⁸SiO_{3/2}, where R⁸ is selected from the group of phenyl groups, propyl groups, and combinations thereof. Another specific example of a polyorganosiloxane that is suitable for purposes of the instant invention is a trimethyl-capped MQ resin. Yet another specific example of a polyorganosiloxane that is suitable for purposes of the instant invention is a polyorganosiloxane comprising a 4:1 blend, by weight, of trimethyl-capped MQ resin and a linear polysiloxane. Blends of resinous components and linear polysiloxanes, in particular, result in the article (12) having excellent mechanical properties, including high yield stress and tear but at the same time, significantly lower elastic modulus, thereby resulting in articles (12) (in particular non-woven mats including the fibers (14)) that have minimal fragility and maximized elasticity.

Further, the organopolysiloxane may have the formula:

(R₃SiO_{1/2})_{w}(R₂SiO_{2/2})ₓ(RSiO_{3/2})_{y}(SiO_{4/2})_{z}

wherein each R is independently selected from the group of an inorganic group, an organic group, and combinations thereof and may be the same or different and may be any of those groups described above or below. Additionally, w is from 0 to about 0.95, x is from 0 to about 0.95, y is from 0 to 1, z is from 0 to about 0.9, and w+x+y+z=1. Alternatively, the organopolysiloxane may include a cured product of the aforementioned organopolysiloxane or a combination of the organopolysiloxane and the cured product. In the above formula, the subscripts w, x, y, and z are mole fractions. The subscript w alternatively has a value of from 0 to about 0.8, alternatively from 0 to about 0.2; the subscript x alternatively has a value of from 0 to about 0.8, alternatively from 0 to about 0.5; the subscript y alternatively has a value of from about 0.3 to 1, alternatively from about 0.5 to 1; the subscript z alternatively has a value of from 0 to about 0.5, alternatively from 0 to about 0.1. In one embodiment, y+z is less than about 0.1, and w and x are each independently greater than 0. In this embodiment, it thus becomes clear that the organopolysiloxane has either no T and/or Q units (in which case the organopolysiloxane is an MD polymer), or has a very low amount of such units. In this embodiment, the organopolysiloxane has a number average molecular weight (Mₙ) of at least about 50,000 g/mol, more typically at least 100,000 g/mol. Of course, it is to be appreciated that in embodiments in which y+z is less than about 0.1, the organopolysiloxane component may require higher Mₙ values, as set forth above, to achieve desired properties.

Further, the compound may include a blend of organopolysiloxanes so long as at least one of the organopolysiloxanes is functionalized with the Si—H group. The blend may include an organopolysiloxane that has the formula (R⁹₃SiO_{1/2})_{w′}(R⁹₂SiO_{2/2})_{x′}, wherein R⁹ is selected from the group of an inorganic group, an organic group, and combinations thereof, w′ and x′ are independently greater than 0, and w′+x′=1. In effect, this organopolysiloxane is a linear organopolysiloxane. In this formula, w′ is typically a number ranging from about 0.003 to about 0.5, more typically from about 0.003 to about 0.05, and x′ is typically a number ranging from about 0.5 to about 0.999, more typically from about 0.95 to about 0.999.

The organopolysiloxane may also include crosslinks, in which case a cross-linker of the organopolysiloxane typically has a crosslinkable functional group that may function through known crosslinking mechanisms to crosslink individual polymers within the organopolysiloxane. It is to be appreciated that when the organopolysiloxane includes crosslinks, such crosslinks may be formed prior to, during, or after formation of the fibers (14). As such, the presence of crosslinks in the organopolysiloxane in the fibers (14) does not necessarily mean that the fibers (14) must be formed from the composition that includes the cross-linker. The cross-linker may include any reactant or combination of reactants that forms the organopolysiloxane and may include, but are not limited to, hydrosilanes, vinylsilanes, alkoxysilanes, halosilanes, silanols, and combinations thereof.

It is also contemplated that the compound and/or fibers (14) may be formed from a composition. The composition may be, for example, a solution including the compound and a carrier solvent, which is described in greater detail below. Such a composition can, therefore, include the monomers, dimers, oligomers, polymers, pre-polymers, co-polymers, block polymers, star polymers, graft polymers, random co-polymers, first and second organic monomers, the organic monomer and the silicon monomer, the at least two silicon monomers, and combinations thereof that are used to form the compound or that are the compound, so long as the compound has the general formula R—Si—H. In various embodiments, the composition includes the organopolysiloxane described above, the cross-linker, also described above, and/or combinations of both the organopolysiloxane and the cross-linker. In another embodiment, the composition is free from organic polymers, organic copolymers, and precursors thereof. In this embodiment, the terminology “organic polymers” include polymers having a backbone consisting only of carbon-carbon bonds. The “backbone” of a polymer refers to the chain that is produced as a result of polymerization and the individual atoms that are included in that chain. However, the organic polymers may still be branched. In one embodiment, organic homopolymers, as well as all-organic copolymers are specifically excluded. Additionally, organosiloxane-organic copolymers, i.e., those having both carbon atoms and silicon atoms in the backbone of the polymer, may also be excluded.

The composition may also include the carrier solvent first introduced above. In one embodiment, the organopolysiloxane and/or cross-linker and optional additives and/or other polymers may form a solids portion of the composition that remains in the fibers (14) after formation of the fibers (14). In this embodiment, the composition may be characterized as a dispersion of the organopolysiloxane and/or cross-linker, as well as any optional additives and/or other polymers, in the carrier solvent. The function of the carrier solvent is merely to carry the solids portion. During formation of the fibers (14), the carrier solvent(s) typically evaporate away from the composition, thereby leaving the solid portion of the composition. Suitable carrier solvents, for purposes of the instant invention, include any solvent that allows for the formation of homogeneous solution mixtures with the solids portion. Typically, the carrier solvent is capable of solubilizing the solids portion and also possesses a native vapor pressure in the range of from about 1 to about 760 torr at a temperature of about 25° C. Typical carrier solvents also have a dielectric constant (at the temperatures at which the fibers (14) are formed) of from about 2 to about 100. Common carrier solvents suitable for purposes of the instant invention and their physical properties are shown in Table 1 and include, but are not limited to, ethanol, isopropyl alcohol, toluene, chloroform, tetrahydrofuran, methanol, dimethylformamide, water, low molecular weight silicones such as, octamethylcyclotetrasiloxane (D4), decamethylcyclopentasiloxane (D5), octamethyltrisiloxane (MDM), decamethyltetrasiloxane (MD2M), dodecamethylpentasiloxane (MD3M), related materials, and combinations thereof. Additionally, suitable carrier solvents include low molecular weight silicone materials, e.g., cyclosiloxanes and linear siloxanes having a viscosity of less than 10 centistokes at 25° C. such as polydimethylsiloxane (PDMS). Blends of carrier solvents may also be used to yield the most favorable combination of solubility of the solids portion, vapor pressure and dielectric constant.

TABLE 1

| | Molecular | Dielectric | Vapor Pressure |
|---|---|---|---|
| Carrier Solvent | Formula | Constant | at 25° C. (torr) |
| Toluene | C₇H₈ | 2.5 | 22 (at 20° C.) |
| Chloroform | CHCl₃ | 4.8 | ~250 |
| Tetrahydrofuran (THF) | C₄H₄O | 7.5 | ~200 |
| Methanol | CH₃OH | 32.6 | 94 (at 20° C.) |
| Dimethlyformamide | C₃H₇NO | 36.7 | ~10 |
| Water | H₂O | 80.2 | 24 |

The composition may have a viscosity of at least 20 centistokes at a temperature of 25° C. In various embodiments, the composition has a viscosity of at least 20 centistokes, more typically from about 30 to about 100 centistokes, most typically from about 40 to about 75 centistokes at a temperature of 25° C. using a Brookfield rotating disc viscometer equipped with a thermal cell and an SC4-31 spindle operated at a constant temperature of 25° C. and a rotational speed of 5 rpm. The composition may also have a zero shear rate viscosity of from 0.1 to 10, from 0.5 to 10, from 1 to 10, from 5 to 8, or about 6, PaS. Additionally, the first and second organic monomers, the organic monomer and the silicon monomer, or the at least two silicon monomers may be present in the composition in an amount of from about 5% to about 95% by weight based on the total weight of the composition. Further, the composition may have a solids content of from about 5% to about 95% by weight, more typically from about 30% to about 95%, most typically from about 50% to about 70% by weight, based on the total weight of the composition.

The composition may have a conductivity of from 0.01-25 mS/m. In various embodiments, the conductivity of the composition ranges from 0.1-10, from 0.1-5, from 0.1-1, from 0.1-0.5, or is about 0.3, mS/m. The composition may also have a surface tension of from 10-100 mN/m. In different embodiments, the surface tension ranges from 20-80, or from 20-50, mN/m. In one embodiment, the surface tension of the composition is about 30 mN/m. The composition may also have a dielectric constant of from 1-100. In various embodiments, the dielectric constant is between 5-50, 10-70, or 1-20. In one embodiment, the dielectric constant of the composition is about 10.

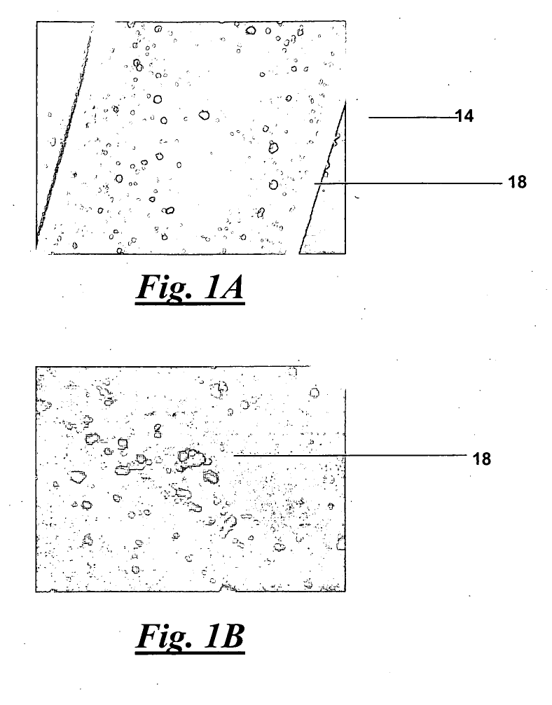

Referring back to the fibers (14), the fibers (14) have a metal (18) disposed thereon, as shown in FIGS. 1-6. It is to be understood that the terminology “metal” may include elemental metals, metal alloys, metal ions, metal atoms, metal salts, organic metal compounds, metal particles including physically bound collections of metal atoms and chemically bound collections of metal atoms, and combinations thereof. The metal (18) may be any known in the art and may be disposed on the fibers (14) by reaction of its ion with Si—H. In one embodiment, the metal (18) is selected from the group of copper, technetium, ruthenium, rhodium, palladium, silver, rhenium, osmium, iridium, platinum, gold, and combinations thereof. In another embodiment, the metal (18) is selected from the group of gold, silver, platinum, palladium, rhodium, iridium, salts thereof, and combinations thereof. In a further embodiment, the metal (18) is a noble metal. Although a noble metal is typically thought to be mostly unreactive, for purposes of the instant invention, the noble metal may react with the Si—H of the compound. The metal (18) may also be further defined as a salt of a noble metal or of any of the metals described above.

The metal (18) may be disposed on the fibers (14) in any manner known in the art. In one embodiment, the metal (18) is physically disposed on the fibers (14). In another embodiment, the metal (18) is bonded to the fibers (14) such that the metal (18) is chemically disposed on the fibers (14), as also shown in FIG. 11. In a further embodiment, the metal (18) is agglomerated into particles. The particles may be nanoparticles, nanopowders, nanoclusters, and/or nanocrystals. Typically, the particles have a size of from 1 to 500, more typically of from 2 to 100, and most typically of from 5 to 10, nanometers. As is known in the art, nanoparticles, nanopowders, nanoclusters, and/or nanocrystals include microscopic (metal) particles with at least one dimension less than 100 nm. Without intending to be bound by any particular theory, it is believed that these types of particles (e.g. nanoparticles) can have high surface areas which may be important for applications involving catalysis, light capture, and absorption because of increased active areas and greater activities. It is also believed that quantum confinement effects, resulting from the size of the particles, may allow the particles to exhibit unique electrical, optical, and/or magnetic phenomena.

In another embodiment, the metal (18) forms a film disposed on the fibers (14). The film may be a monolayer film of metal atoms. The metal (18) may be in contact with the fibers (14) and not bonded to the fibers (14). Alternatively, the metal (18) may be bonded to the fibers (14). In one embodiment, various metal atoms are in contact with the fiber and not bonded to the fiber while other atoms are simultaneously bonded to the fiber. Typically, the metal (18) is bonded to the fibers (14) via a reduction reaction with the Si—H of the compound. Without intending to be bound by any particular theory, it is believed that the Si—H of the compound acts as a reducing agent and reduces the metal (18) (e.g. an ion of the metal) from a first cationic state to a lower cationic state or to an elemental state (e.g. M⁰).

It is to be understood that the terminology “a metal” or (“the metal”) includes one metal or more than one metal. In other words, the fibers (14) may include a single metal or more than one metal disposed thereon. Of course it is to be understood that a “single metal” refers to a single type of metal and is not limited to a single metal atom. In one embodiment, the fibers (14) include a first and a second metal disposed thereon. The first and second metals, and any additional metals, may be the same or may be different from each other and may be any of the metals described above. The second metal may be bonded to the fibers (14) even if the first metal is not. Alternatively, the second metal may be in contact with the fibers (14) but not bonded to the fibers (14) while the first metal is bonded to the fibers (14). Alternatively both the first and second metals may be simultaneously bonded to the fibers (14) or may be simultaneously in contact with the fibers (14) without being bonded to the fibers (14).

In one embodiment, the article (12) is of fibers (14) which include the reaction product of the compound and the metal (18). In another embodiment, the article (12) is further defined as a mat including non-woven fibers (14) that are electrospun and are formed from the reaction product of the compound and the metal (18) selected from the group of copper, technetium, ruthenium, rhodium, palladium, silver, rhenium, osmium, iridium, platinum, gold, and combinations thereof. As set forth above, if the compound reacts with the metal (18), ions of the metal typically react via a reduction reaction with the Si—H of the compound. It is believed that this reduces the metal ions from the first cationic state to the lower cationic state or to the elemental state, as also set forth above. In all of these embodiments, the compound and the metal (18) may be the same as described above. When the metal (18) is disposed on the fibers (14), the fibers can change color indicating a presence of the metal (18) in an elemental state.

The fibers (14), compound, and/or composition may also include an additive. The additive may include, but is not limited to, conductivity-enhancing additives, surfactants, salts, dyes, colorants, labeling agents, and combinations thereof. Conductivity-enhancing additives may contribute to excellent fiber formation, and may further enable diameters of the fibers (14) to be minimized, especially when the fibers (14) are formed through electrospinning, as described in detail below. In one embodiment, the conductivity-enhancing additive includes an ionic compound. In another embodiment, the conductivity-enhancing additives are generally selected from the group of amines, organic salts and inorganic salts, and mixtures thereof. Typical conductivity-enhancing additives include amines, quaternary ammonium salts, quaternary phosphonium salts, ternary sulfonium salts, and mixtures of inorganic salts with organic ligands. More typical conductivity-enhancing additives include quaternary ammonium-based organic salts including, but not limited to, tetrabutylammonium chloride, tetrabutylammonium bromide, tetrabutylammonium iodide, phenyltrimethylammonium chloride, phenyltriethylammonium chloride, phenyltrimethylammonium bromide, phenyltrimethylammonium iodide, dodecyltrimethylammonium chloride, dodecyltrimethylammonium bromide, dodecyltrimethylammonium iodide, tetradecyltrimethylammonium chloride, tetradecyltrimethylammonium bromide, tetradecyltrimethylammonium iodide, hexadecyltrimethylammonium chloride, hexadecyltrimethylammonium bromide, and hexadecyltrimethylammonium iodide. When present in the fibers (14), the additive may be present in an amount of from about 0.0001 to about 25%, typically from about 0.001 to about 10%, more typically from about 0.01 to about 1% based on the total weight of the fibers (14) in the article (12).

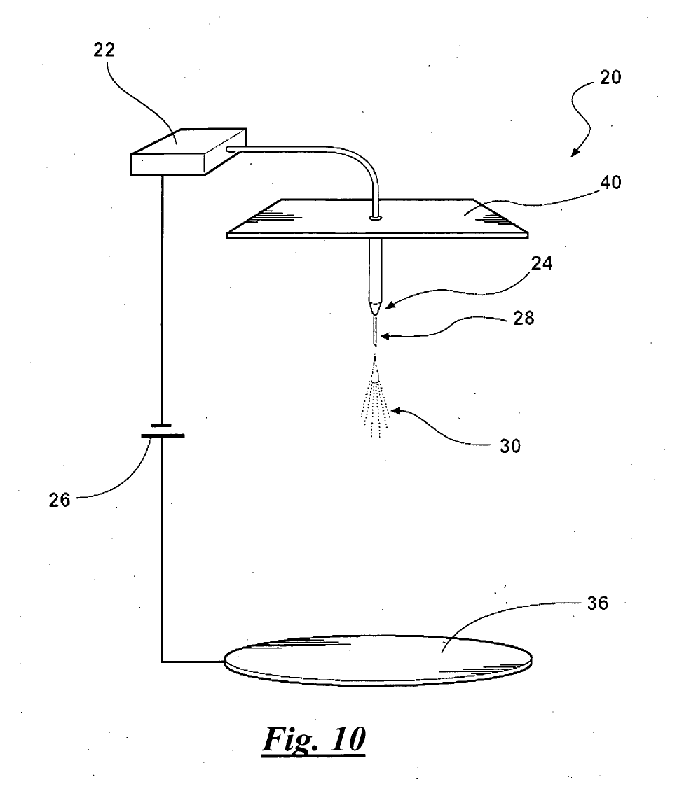

In addition to the article (12), the present invention also provides a method of manufacturing the article (12). The article (12) may be manufactured by any method known in the art including, but not limited to, electrospinning, electroblowing, and combinations thereof. In one embodiment, the method includes the step of electrospinning the compound (which may be included with a solvent, for example, in an overall composition) to form the fibers (14). The step of electrospinning may be conducted by any method known in the art. The step of electrospinning may utilize an electrospinning apparatus (20), such as the one set forth in FIG. 10. Of course, the instant method is not limited to use of such an apparatus.

As is known in the art, the step of electrospinning typically includes use of an electrical charge to form the fibers (14). Typically, the composition used to form the fibers (14) is loaded into a syringe (22) and driven to a tip (24) of the syringe (22) with a syringe pump. Subsequently, a droplet is formed at the tip (24) of the syringe (22). The syringe pump enables control of flow rate of the composition used to form the fibers (14). Flow rate of the composition used to form the fibers (14) through the tip (24) of the syringe (22) may have an effect on formation of the fibers (14). The flow rate of the composition through the tip (24) of the syringe (22) is typically of from about 0.005 ml/min to about 10 ml/min, more typically of from about 0.005 ml/min to about 0.1 ml/min, still more typically of from about 0.01 ml/min to about 0.1 ml/min, and most typically of from about 0.02 ml/min to about 0.1 ml/min. In one embodiment, the flow rate of the composition through the tip (24) of the syringe (22) is about 0.05 ml/min. In another embodiment, the flow rate of the composition through the tip (24) of the syringe (22) is about 1 ml/min.

After formation, the droplet is typically exposed to a high-voltage electric field. In the absence of the high-voltage electrical field, the droplet usually exits the tip (24) of the syringe (22) in a quasi-spherical shape, which is the result of surface tension in the droplet. Application of the electric field typically results in the distortion of the spherical shape into that of a cone. The generally accepted explanation for this distortion in droplet shape is that the surface tension forces within the droplet are neutralized by the electrical forces. Narrow diameter jets (28) of the composition emanate from a tip of the cone, as shown in FIG. 10. Under certain process conditions, the jet (28) of the composition undergoes the phenomenon of “whipping” instability (30) as shown in FIG. 10. This whipping instability (30) results in repeated bifurcation of the jet (28), yielding a network of the fibers (14). The fibers (14) are typically collected on a collector plate (36). When the composition includes the carrier solvent, the carrier solvent typically evaporates during the electrospinning process, leaving behind the solids portion of the composition to form the fibers (14).

The collector plate (36) is typically formed from a solid conductive material such as, but not limited to, aluminum, steel, nickel alloys, silicon waters, Nylon® fabric, and cellulose (e.g., paper). The collector plate (36) acts as a ground source for the electron flow through the fibers (14) during electrospinning of the fibers (14). As time passes, the number of fibers (14) collected on the collector plate (36) increases and a non-woven fiber mat, for example, is formed on the collector plate (36). Alternatively, instead of using the collection plate, the fibers, (14) may be collected on the surface of a liquid that is a non-solvent of the composition or compound, thereby achieving a free-standing article, such as a free-standing non-woven mat. One example of liquid that can be used to collect the fibers (14) is water.

In various embodiments, the step of electrospinning comprises supplying electricity from a power source (26), e.g. a DC generator, shown in FIG. 10, having generating capability of from about 10 to about 100 kilovolts (KV). In particular, the syringe (22) is electrically connected to the generator (26). The step of exposing the droplet to the high-voltage electric field typically includes applying a voltage and an electric current to the syringe (22). The applied voltage may be from about 5 KV to about 100 KV, typically from about 10 KV to about 40 KV, more typically from about 15 KV to about 35 KV, most typically from about 20 KV to about 30 KV. In one specific example, the applied voltage may be about 30 KV. The applied electric current may be from about 0.01 nA to about 100,000 nA, typically from about 10 nA to about 1000 nA, more typically from about 50 nA to about 500 nA, most typically from about 75 nA to about 100 nA. In one embodiment, the electric current is about 85 nA.

During the step of supplying electricity, as described above, the collector plate (36) may function as a first electrode and may be used in combination with a top plate (40) functioning as a second electrode, as shown in FIG. 10. The collector plate (36) and the top plate (40) may be spaced at a distance of from about 0.001 cm to about 100 cm, typically from about 20 cm to about 75 cm, more typically from about 30 cm to about 60 cm, and most typically from about 40 cm to about 50 cm relative to each other. In one embodiment, the collector plate (36) and the top plate (40) are spaced at a distance of about 50 cm.

Typically, when electrospinning, the compound is a solid or semi-solid within 60° C. of ambient temperature. More typically, when electrospinning, the compound is a solid or semi-solid within 60° C. of a processing temperature. In one embodiment, the step of electrospinning is further defined as electrospinning the compound in solution, e.g. electrospinning the composition, as first introduced above.

In addition to, or as an alternative to, the step of electrospinning, the method may include the step of electroblowing the compound, as first introduced above. The step of electroblowing typically includes forming a droplet of a composition, such as the composition of this invention, at a tip of a syringe and exposing the droplet to a high-voltage electric field. In addition, a stream of a blowing or forwarding gas is typically applied to the droplet to form fibers on a collector plate. Non-limiting examples of suitable electroblowing methods and equipment are described in WO 2006/017360. The sections of WO 2006/017360 specifically directed at these methods and equipment are hereby expressly incorporated by reference.

In addition to the steps of electrospinning and/or electroblowing, the method also includes the step of disposing the metal (18) onto the fibers (14) to form the article (12). The step of disposing may occur by any method known in the art. In one embodiment, the step of disposing includes contacting the metal (18) and the fibers (14). In another embodiment, the step of disposing includes reacting the metal (18) with the Si—H of the compound. In yet another embodiment, the step of disposing is further defined as reacting the Si—H of the compound with the metal (18) via a reduction reaction. The step of disposing may be further defined as disposing a single metal or multiple metals on the fibers (14). In one embodiment, the step of disposing is further defined as immersing the fibers (14) in a solution including the metal (18), which is described in greater detail below.

Alternatively, it is contemplated that the method may also include the step of immersing the compound in the solution including the metal (18). In one embodiment, the step of disposing is further defined as immersing the fibers (14) in the solution and the method also includes the step of immersing the compound in the solution. In an alternative embodiment, the solution is an aqueous solution. In another embodiment, the metal (18) is added to the solution as a metal salt or salts which may include, but are not limited to, halide salts such as chlorides and salts of the general chemical formulas: [X⁺][Y⁺][Z⁻] or [Y⁺][Z⁻], wherein X may be a metal, hydrogen atom, or cation producing species, Y is the metal (18) of the instant invention, and Z is an anion producing species. In each of these salts, the charges of X and Y and Z should balance to zero. Specific examples of such salts include AuCl₃, PtCl₂, PdCl₂, RhCl₃, IrCl₃.xH₂O, NaAuCl₄, HAuCl₄, KPtCl₆, AgNO₃, Ag(OCOR) wherein R is an alkyl or aryl group, CuX or CuX₂ wherein X is a halogen, Cu(OOCR)₂ wherein R is an alkyl or aryl group, and combinations thereof.

The method may also include the step of annealing the fibers (14). This step may be completed by any method known in the art. In one embodiment, the step of annealing may be used to enhance the hydrophobicity of the fibers (14). In another embodiment, the step of annealing may enhance a regularity of microphases of the fibers (14). The step of annealing may include heating the article (12). Typically, to carry out the step of annealing, the article (12) is heated to a temperature above ambient temperature of about 20° C. More typically, the article (12) is heated to a temperature of from about 40° C. to about 400° C., most typically from about 40° C. to about 200° C. Heating of the article (12) may result in increased fusion of fiber junctions within the article (12), formation of chemical or physical bonds within the fibers (14) (generally termed “cross-linking”), volatilization of one or more components of the fiber, and/or a change in surface morphology of the fibers (14).

### EXAMPLES

Two series of fibers and corresponding non-woven mats (i.e., articles of the instant invention) are formed according to the present method. A first series of non-woven mats include fibers formed from the compound including the polymerization product of a first and a second silicon monomer. A second series of non-woven mats include fibers formed from the compound including the polymerization product of a silicon monomer and an organic monomer. After formation, each of the fibers are exposed to a solution including the metal to dispose the metal on the fibers and form the articles of the instant invention.

Fibers Formed from the Polymerization Product of a First and a Second Silicon Monomer

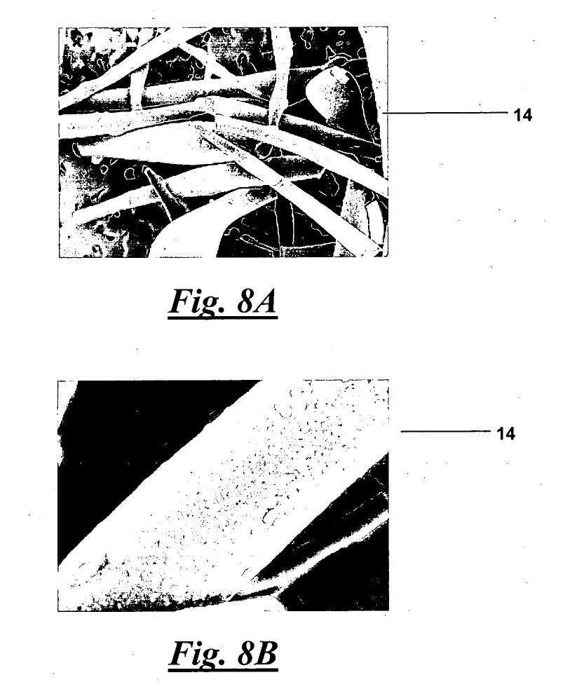

4.8 g of an organopolysiloxane represented by the general formula [R₃SiO_{1/2}][SiO_{4/2}], wherein R is a methyl group and 1.2 g of a methylhydrogen silicone having a degree of polymerization of 50 are combined with 4 g of a 1:1 mixture of isopropyl alcohol and dimethylformamide and mixed to form a solution. After mixing, the solution is clear, colorless, and homogeneous. The solution is then loaded into a syringe and delivered to a stainless steel tip (inner diameter 0.040 in.) of the syringe which is attached to a syringe pump. The syringe pump forms a droplet of the solution at the tip of the syringe. An electric field is applied to the droplet at the end of the tip and the droplet is stretched into thin white fibers which are ejected (electrospun) onto a grounded piece of aluminum foil. The step of electrospinning is performed at a plate gap of 20 cm, tip protrusion of 3 cm, voltage of 35 kV, and flow rate of 10 mL/hr. The white fibers that are formed have average diameters of 10 microns and smooth surfaces with some pockmarks, as shown in FIGS. 8A and 8B. The fibers are then scraped off of the aluminum foil and used for further reaction.

Fibers Formed from the Polymerization Product of a Silicon Monomer and an Organic Monomer

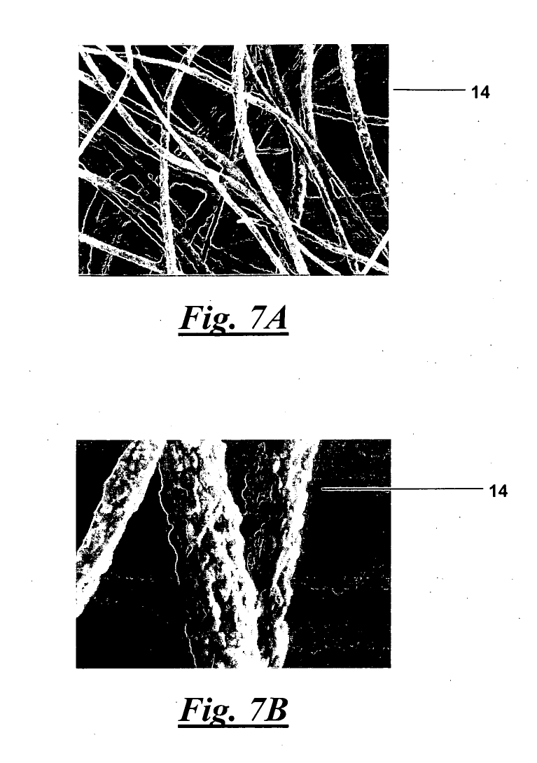

12 g of a silicone polyetherimide copolymer having a T_{g} of about 168° C. and 3 g of the methylhydrogen silicone having a degree of polymerization of 50 are combined with 48 g of a 2:1 mixture of dichloromethane and dimethylformamide and mixed to form a solution. After mixing, the solution is yellow and opaque. The solution is then loaded into a syringe and delivered to a stainless steel tip (inner diameter 0.040 in.) of the syringe which is attached to a syringe pump. The syringe pump forms a droplet of the solution at the tip of the syringe. An electric field is applied to the droplet at the end of the tip and the droplet is stretched into thin white fibers which are ejected (electrospun) onto a grounded piece of aluminum foil. The step of electrospinning is performed at a plate gap of 30 cm, tip protrusion of 3 cm, voltage of 30 kV, and flow rate of 1 mL/min. The white fibers that are formed have average diameters of 10 microns and a bumpy surface texture, as shown in FIGS. 7A and 7B. The fibers are then scraped off of the aluminum foil and used for further reaction.

The Fibers Formed From the Polymerization Product of the First and the Second Silicon Monomer are then functionalized with the metal. That is, the metal is then disposed on the fibers, according to the following methods.

Gold Disposed on the Fibers

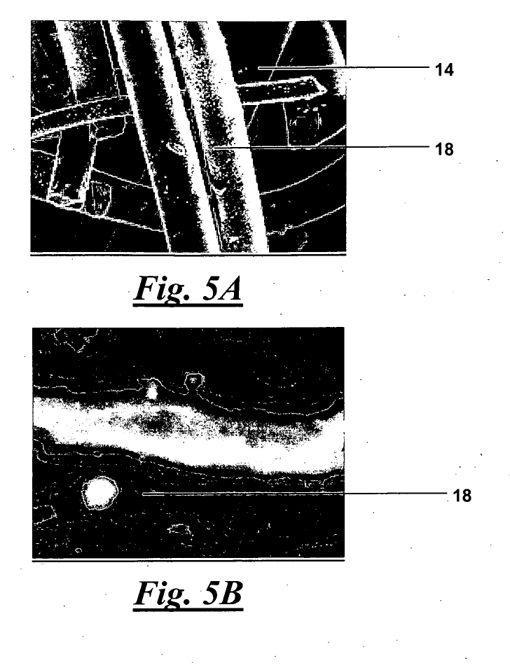

0.01 g of AuCl₃ are added to 10 g of a 1:1 solution of H₂O/ethanol. A small amount of the fibers are then placed in an excess of the solution in a Petri dish. After five minutes, a light magenta color is visible on a surface of the fibers. After thirty minutes, this color changes to a deep magenta. Scanning electron microscope images of the fibers indicate the presence of discrete rounded bumps on the surface of the fibers, as shown in FIGS. 5A and 5B. These bumps range in size from 5-500 nm in diameter and are spread over the entire surface of the fibers. Elemental spectroscopy for chemical analysis (ESCA) detects only a trace of chlorine (Cl) on the surface of the fibers, indicating that the Au⁺³ is reduced by the Si—H to form Au⁰ nanoparticles. The fibers, including the metal disposed thereon, form, the article of the present invention.

Silver Disposed on the Fibers

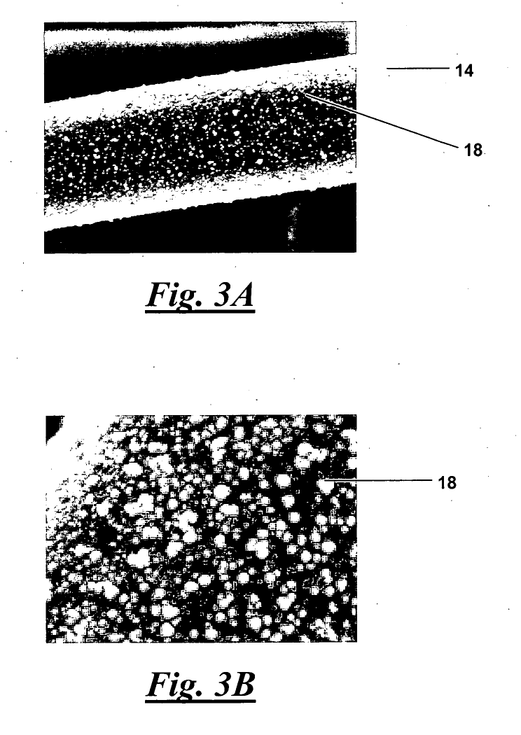

0.01 g of AgNO₃ are added to 10 grams a 1:1 solution of H₂O/ethanol resulting in a colorless solution. A small amount of the fibers are then placed in an excess of the solution in a Petri dish. After one hour, a yellow color is visible at the surface of the fibers. Scanning electron microscope images of the fibers indicate the presence of discrete rounded bumps on the surface of the fibers, as shown in FIGS. 3A and 3B. These bumps range in size from 5-500 nm in diameter and are spread over the entire surface of the fibers. Elemental spectroscopy for chemical analysis (ESCA) detects only a trace of nitrogen (N) on the surface of the fibers, indicating that the Ag⁺¹ is reduced by the Si—H to form Ag⁰ nanoparticles. The fibers, including the metal disposed thereon, form, the article of the present invention.

Platinum Disposed on the Fibers

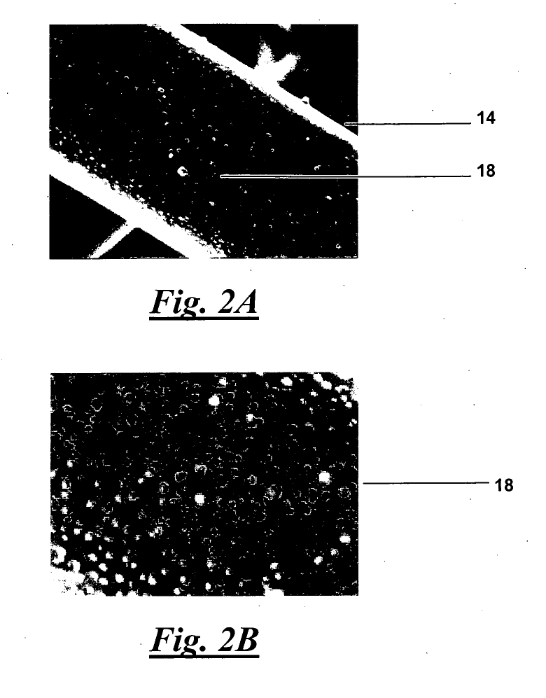

0.01 g of PtCl₂ are added to 10 g of a 0.1% by weight solution of 9% polyethylene glycol, 15% poly(ethyleneoxide)monoallyl ether, and 76% 1,1,1,3,5,5,5-heptamethyl-3-(propyl(poly(EO))hydroxy) trisiloxane in H₂O, resulting in a yellow-gray solution. A small amount of fibers are then placed in an excess of the solution in a Petri dish. After 24 hours, a light gray color is visible at the surface of the fibers. Scanning electron microscope images of the fibers indicate the presence of discrete rounded bumps on the surface of the fibers, as shown in FIGS. 2A and 2B. These bumps range in size from 5-500 nm in diameter and are spread over the entire surface of the fibers. Elemental spectroscopy for chemical analysis (ESCA) detects only a trace of chlorine (Cl) on the surface of the fibers, indicating that the Pt⁺² is reduced by the Si—H to form Pt⁰ nanoparticles. The fibers, including the metal disposed thereon, form, the article of the present invention.

Palladium Disposed on the Fibers

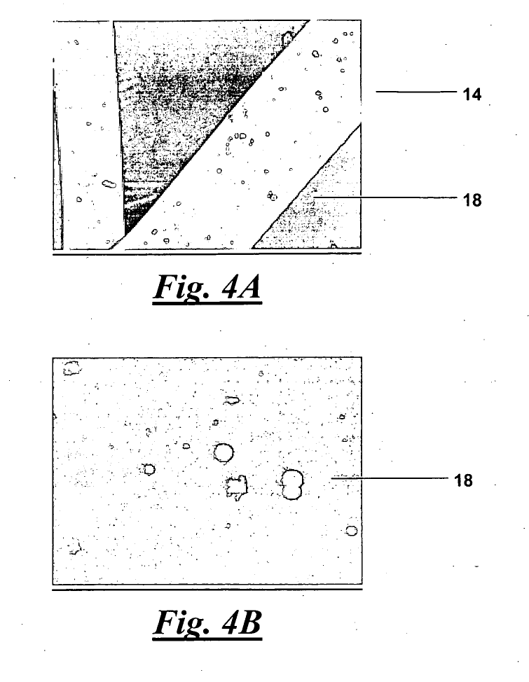

0.01 g of PdCl₂ are added to 10 g of a 0.1% by weight solution of 9% polyethylene glycol, 15% poly(ethyleneoxide)monoallyl ether, and 76% 1,1,1,3,5,5,5-heptamethyl-3-(propyl(poly(EO))hydroxy) trisiloxane, resulting in a light gray solution. A small amount of fibers are then placed in an excess of the solution in a Petri dish. After 48 hours, a black color is visible at the surface of the fibers. Scanning electron microscope images of the fibers indicate the presence of discrete rounded bumps on the surface of the fibers, as shown in FIGS. 4A and 4B. These bumps range in size from 5-500 nm in diameter and are spread over the entire surface of the fibers. Elemental spectroscopy for chemical analysis (ESCA) detects only a trace of chlorine (Cl) on the surface of the fibers, indicating that the Pd⁺² is reduced by the Si—H to form Pd⁰ nanoparticles. The fibers, including the metal disposed thereon, form, the article of the present invention.

Rhodium Disposed on the Fibers

0.01 g of RhCl₃ are added to 10 g of a 0.1% by weight solution of 9% polyethylene glycol, 15% poly(ethyleneoxide)monoallyl ether, and 76% 1,1,1,3,5,5,5-heptamethyl-3-(propyl(poly(EO))hydroxy) trisiloxane in H₂O along with approximately 5 g of ethanol, resulting in a greenish-gray solution. A small amount of fibers are then placed in an excess of the solution in a Petri dish. After 24 hours, an orange color is visible at the surface of the fibers. Scanning electron microscope images of the fibers indicate the presence of discrete rounded bumps on the surface of the fibers, as shown in FIGS. 1A and 1B. These bumps range in size from 5-500 nm in diameter and are spread over the entire surface of the fibers. Elemental spectroscopy for chemical analysis (ESCA) detects only a trace of chlorine (Cl) on the surface of the fibers, indicating that the Rh⁺³ is reduced by the Si—H to form Rh⁰ nanoparticles. The fibers, including the metal disposed thereon, form, the article of the present invention.

Iridium Disposed on the Fibers

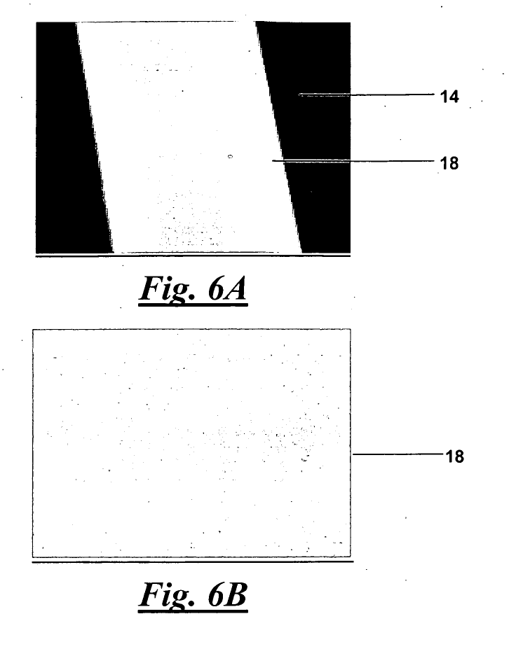

0.01 g of IrCl₃.xH₂O was added to 10 g of a 0.1% by weight solution of 9% polyethylene glycol, 15% poly(ethyleneoxide)monoallyl ether, and 76% 1,1,1,3,5,5,5-heptamethyl-3-(propyl(poly(EO))hydroxy) trisiloxane in H₂O, resulting in a brownish-yellow solution. A small amount of fibers prepared are then placed in an excess of the solution in a Petri dish. After 24 hours, a light yellow color is visible at the surface of the fibers. Scanning electron microscope images of the fibers indicate the presence of discrete rounded bumps on the surface of the fibers, as shown in FIGS. 6A and 6B. These bumps range in size from 5-500 nm in diameter and are spread over the entire surface of the fibers. Elemental spectroscopy for chemical analysis (ESCA) detects only a trace of chlorine (Cl) on the surface of the fibers, indicating that the Ir⁺³ is reduced by the Si—H to form Ir⁰ nanoparticles. The fibers, including the metal disposed thereon, form, the article of the present invention.

The Fibers Formed From the Polymerization Product of the Silicon Monomer and the Organic Monomer are then functionalized with the metal. That is, the metal is then disposed on the fibers, according to the following methods.

Platinum Disposed on the Fibers

0.1 g of PtCl2 is added to a solution of 0.5 g of 9% polyethylene glycol, 15% poly(ethyleneoxide)monoallyl ether, and 76% 1,1,1,3,5,5,5-heptamethyl-3-(propyl(poly(EO))hydroxy) trisiloxane diluted in 500 g of H₂O in a beaker, resulting in a light gray solution. 4 g of the fibers are then placed in the solution and mixed with a magnetic stir plate. After 24 hours, a gray color is visible at the surface of the fibers. After four days, the fibers are a deep gray color and the solution is colorless. Scanning electron microscope images of the fibers indicate the presence of discrete rounded bumps on the surface of the fibers. These bumps range in size from 5-150 nm in diameter and are spread over the entire surface of the fibers. Elemental spectroscopy for chemical analysis (ESCA) detects only a trace of the element Cl on the surface of the fibers, indicating that the Pt⁺² is reduced by the Si—H to form Pt⁰ nanoparticles. The fibers, including the metal disposed thereon, form, the article of the present invention.

The Examples set forth above demonstrate that fibers are efficiently formed through electrospinning and a metal is disposed on fibers using the method of the instant invention with a minimal numbers of steps. In addition, the step of electrospinning allows for efficient formation of the fibers having small diameters and for formation of hierarchical structures including nanostructures of the metal disposed on the fibers.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

1. An article comprising fibers formed from a compound having the general chemical formula R—Si—H wherein R is an organic or inorganic group and having a metal disposed thereon via a reduction reaction of said metal with said Si—H of said compound.

2. (canceled)

3. An article as set forth in claim 1 wherein said metal is further defined as a noble metal.

4. An article as set forth in claim 3 wherein said metal is selected from the group of copper, technetium, ruthenium, rhodium, palladium, silver, rhenium, osmium, iridium, platinum, gold, and combinations thereof.

5. An article as set forth in claim 1 wherein said compound is further defined as a monomer which has the general chemical formula R—Si—H.

6. An article as set forth in claim 5 wherein said monomer is selected from the group of silanes, siloxanes, and combinations thereof.

7. An article as set forth in claim 1 wherein R is further defined as a polymerization product of at least a silicon monomer and an organic monomer.

8. An article as set forth in claim 7 wherein said silicon monomer is selected from the group of organosilanes, organosiloxanes, and combinations thereof.

9. An article as set forth in claim 1 wherein R includes an organopolysiloxane comprising siloxane units having an average unit formula of RₓSiO_{y/2}, wherein R is an organic group, x is a number of from 0.1 to 2.2, and y is a number of from 1.8 to 3.9.

10. An article as set forth in claim 1 wherein R is further defined as a polymerization product of at least two silicon monomers.

11. An article as set forth in claim 10 wherein said silicon monomers are selected from the group of organosilanes, organosiloxanes, and combinations thereof.

12. An article as set forth in claim 1 wherein said article is non-woven.

13. An article as set forth in claim 1 wherein said fibers are electrospun.

14. A method of manufacturing an article comprising fibers, said method comprising the steps of:
A. electrospinning a compound to form the fibers wherein the compound has the general chemical formula R—Si—H and R is an organic or inorganic group; and
B. disposing a metal onto the fibers to form the article via a reduction reaction of the metal with the Si—H of the compound.

15. (canceled)

16. A method as set forth in claim 14 further comprising the step of immersing the compound in a solution comprising the metal.

17. A method as set forth in either of claim 14 wherein the metal is further defined as a noble metal.

18. A method as set forth in claim 17 wherein the metal is selected from the group of copper, technetium, ruthenium, rhodium, palladium, silver, rhenium, osmium, iridium, platinum, gold, and combinations thereof.

19. A method as set forth in claim 14 wherein the compound is further defined as a monomer having the general chemical formula R—Si—H.

20. A method as set forth in claim 19 wherein the monomer is selected from the group of silanes, siloxanes, and combinations thereof.

21. A method as set forth in claim 14 wherein R is further defined as a polymerization product of at least a silicon monomer and an organic monomer.

22. A method as set forth in claim 14 wherein R includes an organopolysiloxane comprising siloxane units having an average unit formula of RₓSiO_{y/2}, wherein R is an organic group, x is a number of from 0.1 to 2.2, and y is a number of from 1.8 to 3.9.

23. A method as set forth in claim 14 wherein R is further defined as a polymerization product of at least two silicon monomers.

24. A mat comprising non-woven fibers that are electrospun and are formed from the reaction product of:
(i) a compound having the general chemical formula R—Si—H, wherein R is an organic or an inorganic group; and
(ii) a metal selected from the group of copper, technetium, ruthenium, rhodium, palladium, silver, rhenium, osmium, iridium, platinum, gold, and combinations thereof,
wherein said metal is disposed on said non-woven fibers via a reduction reaction with said Si—H of said compound.

25. An article of fibers which comprise the reaction product of:
A. a compound having the general chemical formula R—Si—H wherein R is an organic or inorganic group; and
B. a metal disposed thereon via a reduction reaction with said Si—H of said compound.

26. An article as set forth in claim 25 wherein said metal is selected from the group of copper, technetium, ruthenium, rhodium, palladium, silver, rhenium, osmium, iridium, platinum, gold, and combinations thereof.

27. An article as set forth in claim 25 wherein said compound is further defined as a monomer having the general chemical formula R—Si—H.

28. An article as set forth in claim 27 wherein said monomer is selected from the group of silanes, siloxanes, and combinations thereof.

29. An article as set forth in claim 25 wherein R is further defined as a polymerization product of at least a silicon monomer and an organic monomer.

30. An article as set forth in claim 25 wherein R is further defined as a polymerization product of at least two silicon monomers.
